(19) United States
(12) Patent Application Publication
(10) Pub. No.: US 2012/0023148 A1
(43) Pub. Date: Jan. 26, 2012

(54) Applying Transcodings In A Determined Order To Produce Output Files From A Source File

(76) Inventors: James Louis Long, Fort Collins, CO (US); Eric Peterson, Fort Collins, CO (US)

(21) Appl. No.: 13/260,309

(22) PCT Filed: Jun. 5, 2009
(86) PCT No.: PCT/US09/46355

§ 371 Date: Sep. 24, 2011

(51) Int. Cl. G06F 17/30

(52) U.S. Cl. 707/827; 707/E17.01

(57) ABSTRACT

Target formats of output files to be derived from the source file (218) are identified. An order of transcodings is determined to apply to produce the output files. The transcodings are applied in the determined order, where the transcodings in the determined order includes transcoding the source file into a first transcoded file, and transcoding the first transcoded file into a second transcoded file, and where the first and second transcoded files are part of the output files.

### BACKGROUND

Files stored in computers can be encoded into various formats. When in use, transcoding can be applied to a file to convert between different encodings. Files subject to encoding can include audio files, video files, image files or other types of files. One example type of transcoding that can be performed involves transcoding a file according to the DVD (Digital Video Disc) format to a file according to the MP4 (Moving Picture Experts Group-4) format. Another example of transcoding involves transcoding a video or image file between different resolutions, such as between a 720×480 resolution and a 360×240 resolution.

If a source file is relatively large, transcoding applied on the source file can take a relatively large amount of time. In a system that has to perform a relatively large number of transcodings for multiple source files, system performance may suffer.

### BRIEF DESCRIPTION OF THE DRAWINGS

Some embodiments of the invention are described with respect to the following figures;

FIG. 1 illustrates transcodings that can be applied from a source file in a determined order, according to an exemplary embodiment;

FIG. 2 is a block diagram of an exemplary arrangement including a server computer in which an embodiment of the invention can be incorporated;

FIG. 3 illustrates a transcoding hierarchy accessible to determine an order of transcodings according to an embodiment;

FIG. 4 is a flow diagram of a process of performing transcodings according to a determined order, according to an embodiment; and

FIG. 5 is a flow diagram of a process of outputting files having target formats produced by application of transcodings according to an embodiment.

### DETAILED DESCRIPTION

In accordance with some embodiments, a mechanism or technique is provided to improve the efficiency of performing transcodings from a source file. The mechanism or technique identifies the transcodings that are to be performed, and determines an order in which the transcodings are to be performed for enhanced efficiency. The determined order involves at least a first transcoding that is applied on the source file to produce a first transcoded file, and a second transcoding applied on the first transcoded file (rather than the source file) to produce a second transcoded file. The first and second transcoded files are part of a collection of output files. By applying the second transcoding on the first transcoded file rather than the source file, efficiency can be improved since the processing involved in transcoding the first transcoded file to produce the second transcoded file would be less than the processing involved in transcoding the source file to produce the second transcoded file (assuming the first transcoded file contains less information than the source file).

The approach of applying at least one transcoding from a transcoded file rather than the source file may be more efficient and can reduce the burden on a computer when performing multiple transcodings from a source file. Conventionally, if multiple output files of varying formats are desired, then multiple transcodings would be applied directly to the source file, which can be computationally expensive and inefficient.

In accordance with some embodiments, if multiple transcodings are to be performed from a source file, a determination is made regarding the corresponding fidelities of output files to be produced by the corresponding transcodings. A “fidelity” of a file refers to the amount of information that is contained in the file. A file with higher fidelity means that the tile contains more information than a file with lower fidelity. As one example, a video file having a 720×480 display resolution has a higher fidelity than a video file having a 360×240 display resolution.

Generally, the source file is considered to have the highest fidelity, and transcodings applied from the source file can reduce the amount of information that is available in the transcoded files, if the desired output files to be produced (by application of transcodings) from the source file include a first output file that has a higher fidelity than a second output file, then the proper order for performing the transcodings is to apply a first transcoding on the source file to produce the first output file, and subsequently, to apply a second transcoding to the first output file to produce the second output file.

The source file from which transcodings are to be applied can be a “media file,” which is any file that contains a relatively rich amount of information, such as an audio file, video file, image file, multimedia file (a file that contains multiple types of media such as text and image, text and video, audio and video, and so forth), or other types of files. In some examples, transcodings applied with respect to a video or image file can produce output video or image files of different display resolutions (e.g., 1920×1080, 1280×720, 1024×768, 720×480, etc), The display resolution of an image or video file refers to the number of distinct pixels that can be displayed. As another example, transcodings applied with respect to an audio file can also produce output audio files of different audio resolutions.

in further examples, transcodings applied with respect to a media file can produce output files having different compression or container formats, such as one or more of the following compression formats: MPEG (Moving Picture Experts Group) formats (e.g., MPEG-4, MPEG-2, MPEG-1); Audio Video Interleave (AVI) format; Digital Video Disc (DVD) format; Device Independent (DVI) format; and so forth.

In sonic cases, a source media file may be a multimedia file that contains multiple media parts (e.g., audio and video, audio and image, etc.). The transcodings may convert the encodings applied to the multiple media parts of the multimedia file.

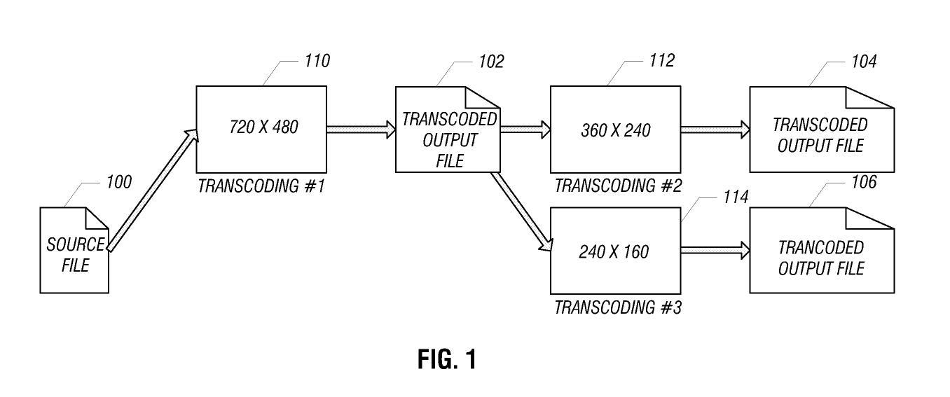

In an example shown in FIG. 1, an order of transcodings to produce output files having different display resolutions from a source video file is illustrated. In FIG. 1, transcodings are to be applied to produce output files 102, 104, and 106 from a source video file 100. In the example, the source video file 100 has a display resolution of 1920×1080. A first transcoding (110) is applied to transcode the source video file 100 into the first output file 102 that has a display resolution of 720×480. Subsequently additional transcodings (112, 114) can be applied to produce respective output files 104, 106, that have respective resolutions of 360×240 and 240×160. Note that the transcodings 112, 114 are applied to the first output file 102 (having the 720×480 resolution), rather than to the source video file 100 (having the 1920×1080 resolution). Note also that the transcodings 112, 114 can be applied to the first output file 102 because the resolution of the first output file 102 is greater than the resolutions of the output files 104, 106—in other words, the fidelity of the first output file 102 is higher than the fidelity of the output files 104, 106.

The order of transcodings (110, 112, 114) to be applied is determined by first identifying the transcodings that are to be performed. From the identified transcodings, an efficient order of transcodings can be determined, where a higher fidelity transcoding is applied directly to the source video file, while lower fidelity transcodings are applied to an intermediate transcoded file rather than to the source video file.

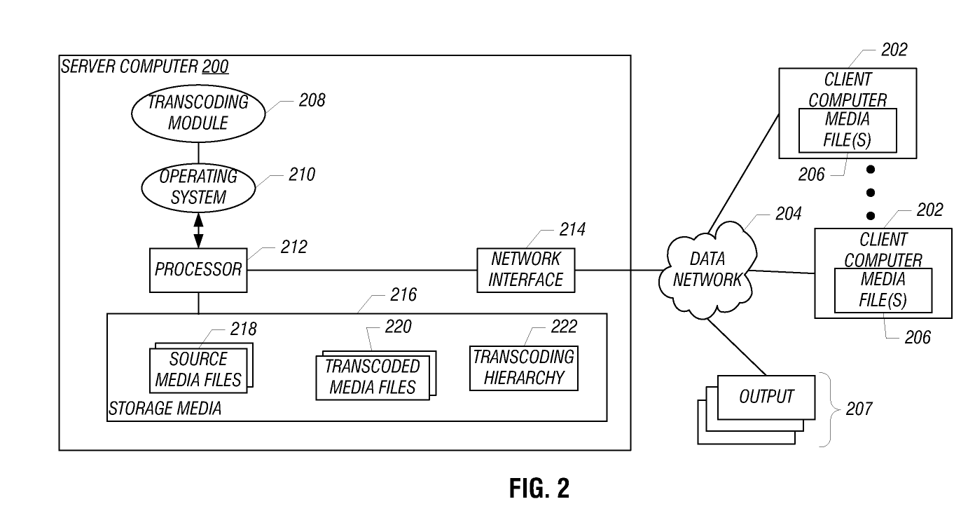

FIG. 2 shows a server computer 200 in which a transcoding mechanism according to some embodiments can be implemented. The server computer 200 is coupled over a data network 204 to client computers 202. Each of the client computers 202 contains one or more media files 206, which can be provided (copied or transferred) to the server computer 200 for storing as source media files 218 in the storage media 216 of the server computer 200. The storage media 216 can include one or more disk-spaced storage devices and/or one or more integrated circuit (IC) storage devices.

The server computer 200 also includes a transcoding module 208 that can apply transcodings. Transcodings can be applied directly to the source media files 218 to produce transcoded media files 220 (also stored in the storage media 216). Also, other transcodings can be applied to sonic of the transcoded media files 220 to produce other transcoded media files 220.

The server computer 200 further includes an operating system 210. The transcoding module 208 and operating system 210 are software that can be executable on a processor 212 of the server computer 200. The processor 212 is connected to the storage media 216 and a network interface 214 that is coupled to the data network 204. The server computer 200 communicates with network devices through the network interface 214 over the data network 204.

One example of the operating system 210 in the server computer 200 can be the WINDOWS® Home Server operating system from Microsoft Corporation. The WINDOWS® Home Server operating system allows various services to be provided, by the server computer 200. For example, the server computer 200 can provide centralized backup of data contained in the client computers 202 connected to the data network 204. The Home Server operating system 210 also allows for the server computer 200 to act as a centralized print server to handle print jobs for the client computers 202. Moreover, the server computer 200 can perform media streaming in which media is streamed to one or inure remote output devices 207 that are connected to the data network 204. The streaming media can include streaming audio and/or video data, “Streaming” data from the server computer 200 to the output devices 207 refers to providing the data for presentation at the output devices 207 as a substantially continuous stream of data.

In addition, the Home Server operating system 210 can allow the server computer 200 to provide data redundancy to protect against data loss due to failure of storage devices in the server computer 200.

in accordance with some embodiments, the transcoding module 208 is able to determine an order of transcodings to be applied for producing multiple output files from a particular source media file. The order of transcodings to be applied can be based on a transcoding hierarchy as represented by a representation 222 stored in the storage media 218.

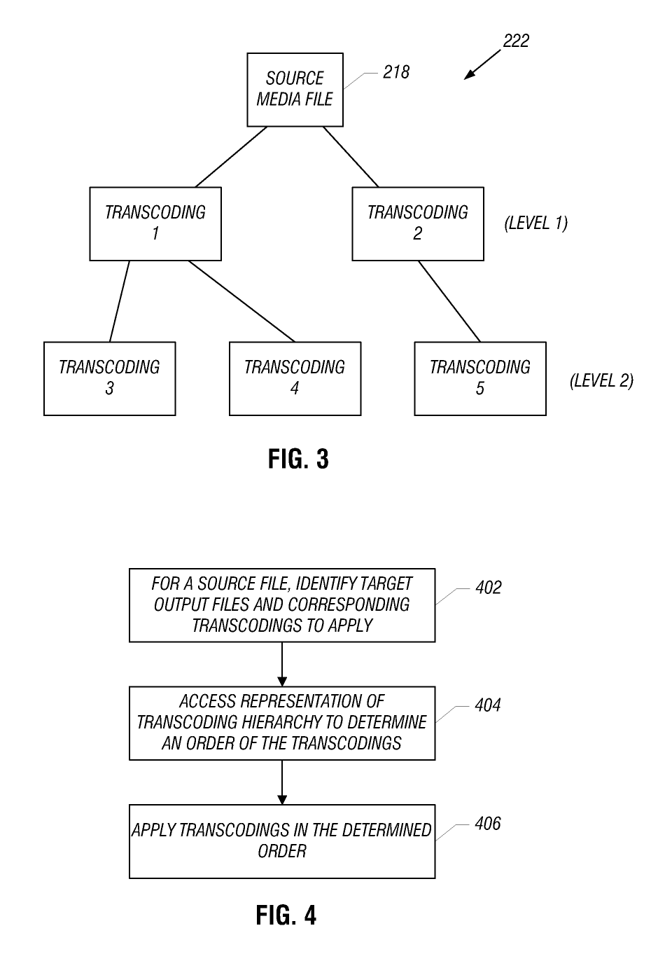

An exemplary representation 222 of the transcoding hierarchy is depicted in FIG. 3. In the hierarchy, which has a tree-like structure, a source media tile 218 is provided at the root of the tree, At the next hierarchical level in the tree (identified as being level 1 in FIG. 3), transcoding 1. and transcoding 2 can be applied directly to the source media file 218 to produce respective transcoded output files. At the next lower hierarchical level (level 2) of the tree, further transcodings can be applied on the transcoded files produced by the transcodings performed at level 1. For example, transcoding 3 and transcoding 4 can be applied on a transcoded output file produced by transcoding 1, while transcoding 5 can be applied on a transcoded output file produced by transcoding 2.

Stated differently, the transcoded files produced by the transcodings at level 1 in the transcoding hierarchy have higher fidelity(ies) than the transcoded files produced by the transcodings at level 2. Thus, the transcodings at level 1 are considered to be higher fidelity transcodings than the transcodings at level 2.

When the transcoding module 208 receives an indication of what output files are desired, the transcoding module 208 consults the representation 222 of the transcoding hierarchy to determine an order of transcodings to apply to achieve optimal efficiency. It is noted that if multiple transcodings at a particular level of the transcoding hierarchy shown in FIG. 3 are to be performed, those transcodings can be performed first before proceeding to the transcodings at the next, lower level of the transcoding hierarchy.

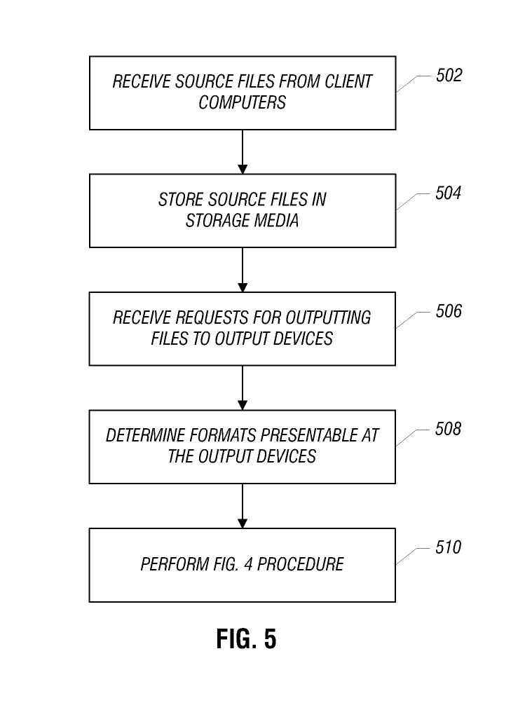

FIG. 4 is a flow diagram of a process according to an embodiment. The process of FIG. 4 can be performed by the transcoding module 208 of FIG. 2. For a source file, the transcoding module 208 identifies (at 402) target output files and corresponding transcodings that are to be applied. The transcoding module 208 then accesses (at 404) a representation (222 in FIG. 2) of the transcoding hierarchy to determine an order of the transcodings that enhances efficiency. The transcodings are ordered from higher fidelity to lower fidelity. The highest fidelity transcoding(s) will use the source file to create first transcoded output file(s). Lower fidelity transcoding(s) can then be applied to the transcoded output file(s) to produce further transcoded output file(s).

In some cases, transcodings cannot always be strictly ordered. One transcoding may specify high resolution video and low resolution audio, while a second transcoding may specify low resolution video and high resolution audio. Alternatively, one transcoding may specify high resolution video or audio, but lossy transcoding, while a second transcoding may specify low resolution audio or video but lossless transcoding. In these scenarios, it may not be possible to apply transcodings in a hierarchical manner, such that the transcodings would have to be applied directly to the source media file.

FIG. 5 illustrates a procedure according to another embodiment. The server computer 200 (FIG. 2) receives (at 502) source files (e.g., media files 206 in FIG. 2) from client computers 202. The source files are stored (at 504) in the storage media 216 of the server computer 200. The server computer 200 then receives (at 506) for outputting files to output devices, such as output devices 207 in FIG. 2. For example, the requests for outputting the files may be requests to stream data (e.g., audio and/or video data) of the files to the output devices.

The output devices 207 may be different types of output devices associated with a user, One output device may be a handheld personal digital assistant (PDA) or smartphone. Another output device may be a handheld music/video player. Yet another output device may he a notebook computer. A further output device may be a high-definition television. These output devices that have different display resolutions (due to different display sizes) are connectable to the server computer 200 to enable the server computer 200 to stream output data for presentation at the output devices.

The server computer 200 determines the formats (at 508) that are presentable at the output devices. Note that some output devices are able to present only certain types of formats. For example, a handheld PDA, smartphone, or handheld music/video player has a relatively small screen and thus can only present video or image data at a relatively low resolution. However, if the output device is a high-definition monitor or television, then the format that can be presented can be at a higher resolution.

Based on the determined formats, the FIG. 4 procedure can then be performed (at 510), where the determined formats specify the target output files that are to be produced and the corresponding transcodings to apply in a determined order for enhanced efficiency.

Instructions of software described above (including the transcoding module 208 and operating system 210 of FIG. 2) are loaded for execution on a processor (such as processor 212 in FIG. 2). The processor includes microprocessors, microcontrollers, processor modules or subsystems (including one or more microprocessors or microcontrollers), or other control or computing devices. As used here, a “processor” can refer to a single component or to plural components (such as one CPU or multiple CPUs on one or multiple computers).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled the art that the present invention may be practiced without these details. While the invention has been disclosed with respect to a limited number of embodiments, those skilled in the art wilt appreciate numerous modifications and variations therefrom. It is intended that the appended claims cover such modifications and variations as fall within the true spirit and scope of the invention.

1. A computer comprising:
storage media to store a source file;
a processor to:
identify target formats of output files to be derived from the source file;
determine an order of transcodings to apply to produce the output files; and
apply the transcodings in the determined order, wherein the transcodings in the determined order includes transcoding the source file into a first transcoded file, and transcoding the first transcoded file into a second transcoded file, wherein the first and second transcoded files are part of the output files.

2. The computer of claim 1, wherein the processor is to further:
access a representation of a transcoding hierarchy to determine the order of the transcodings to apply to produce the output files.

3. The computer of claim 2, wherein the transcoding hierarchy includes a root corresponding to the source file and plural hierarchical levels different from a level of the root, wherein the plural hierarchical levels includes a first level of one or more transcodings that are applied on the source file, and a second level of one or more transcodings that are applied on a transcoded file produced by a transcoding in the first level.

4. The computer of claim 3, wherein the plural hierarchical levels are defined such that a particular transcoded file produced by transcoding of the first level contains sufficient information to allow another transcoding of the second level to produce another transcoded file from the particular transcoded file.

5. The computer of claim 3, wherein the plural hierarchical levels are defined such that a resolution of a particular transcoded file produced by transcoding of the first level is greater than a resolution of another transcoded file produced by another transcoding of the second level.

6. The computer of claim 5, wherein the resolution of the particular transcoded file and the resolution of the another transcoded file comprise one of: video resolutions, image resolutions, and audio resolutions.

7. The computer of claim 1, wherein the source file includes a source media file, wherein the first and second transcoded files are media files having different corresponding encodings than the source media file.

8. The computer of claim 7, wherein the source media file includes one or more of audio data or video data.

9. The computer of claim 1, comprising a media server configured to stream data to one or more output devices over a network, wherein the streamed data includes the output files.

10. The computer of claim 1, wherein the source file is one of plural source files collected by the computer from remote devices over a network.

11. A method of applying transcodings from a source file comprising:
identifying, by a processor, the transcodings that arc to be applied;
determining, by the processor, an order of the transcodings; and
applying, by the processor, the transcodings in the determined order, wherein the transcodings in the predetermined order include a first transcoding applied on the source file to produce a first transcoded file, and a second transcoding applied on the first transcoded file to produce a second transcoded file.

12. The method of claim 11, further comprising outputting the first and second transcoded files as output files.

13. The method of claim 12, wherein outputting the output files comprises streaming the output files over a network to one or more output devices.

14. The method of claim 14, wherein determining the order of the transcodings is based on accessing a representation of a transcoding hierarchy that specifies an order of transcodings from highest fidelity to lowest fidelity.

15. An article comprising at least one computer-readable storage medium containing instructions that upon execution cause a processor to:
receive requests to output files to one or more output devices;
identify formats of the output files, wherein the output files are to be derived from a source file;
determine an order of transcodings to be applied to produce the output files; and
apply the transcodings in the determined order to produce the output files.
